(19) United States
(12) Patent Application Publication
(10) Pub. No.: US 2015/0027102 A1
(43) Pub. Date: Jan. 29, 2015

(54) TRI-PROPELLANT ROCKET ENGINE FOR SPACE LAUNCH APPLICATIONS

(71) Applicants: PATRICK R.E. BAHN, WASHINGTON, DC (US); EARL W. RENAUD, OTTAWA (CA)

(72) Inventors: PATRICK R.E. BAHN, WASHINGTON, DC (US); EARL W. RENAUD, OTTAWA (CA)

(21) Appl. No.: 14/217,469

(22) Filed: Mar. 17, 2014

Related U.S. Application Data
(60) Provisional application No. 61/802,459, filed on Mar. 16, 2013.

(51) Int. Cl. F02K 9/42

(52) U.S. Cl. CPC F02K 9/425
USPC 60/258

(57) ABSTRACT

A tri-propellant rocket engine for space launch applications is disclosed. The tri-propellant rocket engine comprises three main assemblies: an injector, a chamber head, and a chamber.

### CROSS-REFERENCE TO RELATED APPLICATION

The present application claims the priority benefit of U.S. Provisional Patent Application Ser. No. 61/802,459, filed Mar. 16, 2013, which is incorporated herein by reference in its entirety.

### FIELD OF THE INVENTION

The present invention relates generally to rockets and rocket engines. More specifically, the present invention is a throttleable tripropellant rocket engine providing thrust suitable for such applications as but not limited to, vehicular and especially space launch applications.

### BACKGROUND OF THE INVENTION

Rockets and rocket engines are known in the art. Conventional rocket engines have operated using a fixed pair of propellants a fuel and an oxidizer, typically Kerosene/oxygen, hydrogen/oxygen or hydrazine/nitrogen tetroxide. Numerous studies have demonstrated the benefits of a tripropellant rocket engines. Conceptual studies have usually focused upon segmented injectors with spatial separation for propellant pair types which produce cooling challenges.

The Applicant is unaware of inventions or patents, taken either singly or in combination, which are seen to describe the instant invention as claimed.

### SUMMARY OF THE INVENTION

The present invention is a tripropellant rocket engine for such applications as, but not limited to, vehicular and especially space launch applications. The tripropellant rocket engine comprises five main assemblies: chamber head, dual sleeve pintle injector, chamber and throat, independent cooling system, and nozzle.

### BRIEF DESCRIPTION OF THE DRAWINGS

FIG. 1 is a cross-sectional view of a layout drawing of a ground test rocket engine capable of running in a tripropellant mode, showing an exemplary engine with piping and valve manifold, a chamber head, an injector, a chamber and throat, cooling system and nozzle assemblies;

FIG. 2 is a cross-sectional view of an exemplary engine piping and valve manifold, chamber head, and injector assemblies; and

FIG. 3 is a schematic view of an embodiment of a rocket engine system having a tripropellant rocket engine according to the present invention, and showing other supporting components of the rocket engine system, allowing the flexibility of the invention to be shown.

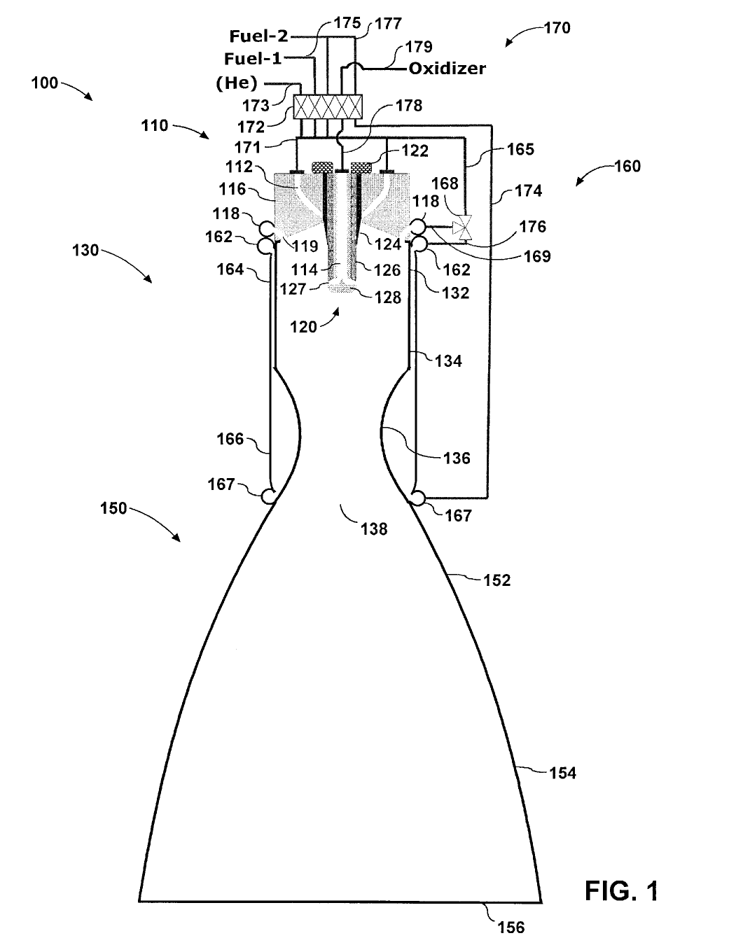

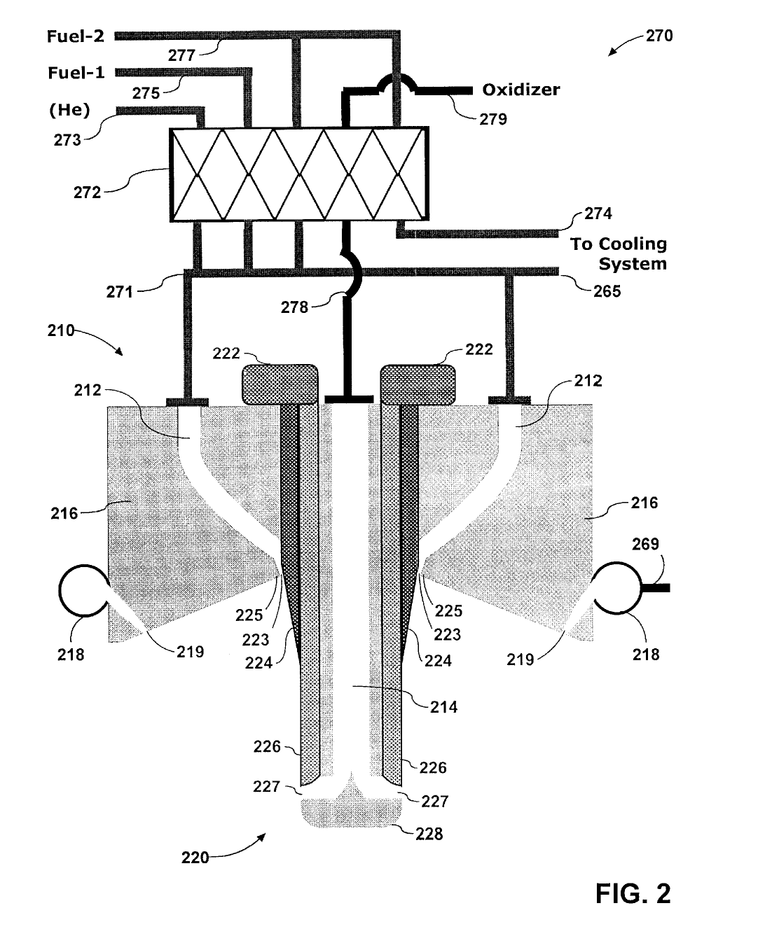

It should be understood that the above-attached figures are not intended to limit the scope of the present invention in any way.

### DETAILED DESCRIPTION OF THE PREFERRED EMBODIMENTS

The present invention is a tripropellant rocket engine 100,300 for space launch applications.

The tripropellant rocket engine 100,300 comprises six main assemblies: a piping and valve manifold assembly 170,270,370, a chamber head assembly 110,210,310, a pintle injector assembly 120,220, a combustion chamber and throat assembly 130, a cooling system assembly 160,360, and a nozzle assembly 150,350.

The chamber head assembly 110,210 is composed of the chamber head 116,216,316, fuel inlet ports 112,212, fuel outlet ring 225, a positioner 122,222, a fuel injector manifold ring 118,218, and fuel injector ports 119,219. Also, the chamber head assembly 110,210 provides mechanical mounting for the pintle injector 120,220.

The independent, dual sleeve pintle injector assembly 120,220 is composed of six main components (not including seals, fasteners, and couplings), which are the oxidizer inlet 114,214, the pintle tip 128,228, the fuel inlet 112,212, the fuel outlet ring 225, the oxidizer sleeve 126,226, and the fuel sleeve 124,224. In operation, the position of the fuel sleeve 124,224 relative to the fuel outlet ring 225 determines the fuel injection area 223, hence controlling fuel mass flow, while the position of the oxidizer sleeve 126,226 relative to the pintle tip 128,228 determines the oxidizer injection area 127,227 and hence the oxidizer mass flow. The two sleeves 124,224,126,226 can be moved independently via a positioner 122,222 or may be fixed and the relative propellant feed pressure may be adjusted.

The combustion chamber and throat assembly 130 is located between the chamber head assembly 110,210 and nozzle assembly 150,350 and enclosed the cooling system assembly 160,360. This consists of the upper chamber wall 132, the lower chamber wall 134 and the throat 136. The chamber and throat assembly 130 provides the volume wherein the fuel and oxidizer combust and the hot gases accelerate while exiting through the throat 138 to the nozzle assembly 150,350.

The nozzle assembly 150,350 allows the gases exiting the throat 136 to expand and leave the rocket engine 100,300. The nozzle bell is defined by the upper section 152,352, lower section 154,354 and exit 156,356.

The combustion chamber and throat assembly 130 has either an adjustable pintle injector 120,220 with face shut off or internal valves (not shown). The throttleable motor has a throat 136 of sufficient size to constrict the combustion products and force flow of about mach one speed at the throat's 136,138 narrowest parts and force flow above supersonic speed in the diverging nozzle assembly 150,350. The pintle injector assembly 120,220 may be described as a pipe within a pipe so that two separate propellants may be supplied and caused to mix at the end point 128,228 at an extreme convergence angle.

The cooling system assembly 160,360 uses fuel-2 177,277,377 to cool the chamber head 116,216, outside and inside walls 132,134 of the chamber and throat assembly 130 and returns through a 3-way diverter valve 168,368 to fuel manifold 171,271,371 or to the fuel injector manifold ring 118,218. This allows the cooling mode to change when the fuel-1 is switched to fuel-2. The coolant path starts at the fuel-2 line 177,277,377, the fuel-2 feed 177,277,377 braches-off and flow through the valve manifold 172,272,372 to cooling feed line 174,274,374 and then to the coolant feed manifold 167. Next, the coolant flows from the manifold 167 into the lower cooling jacket 164,364, flows up to the upper cooling jacket 166,366 and is collected by the coolant return manifold 162, then flows into the cooling return line 176,376 to the 3-way diverter valve 168,368. Finally, the 3-way valve 168,368 routes the coolant through coolant feed line 165,265,365 to fuel manifold 171,271,371 or through injector feed line 169,269,369 to the fuel injector manifold ring 118,218, where the coolant flows through the injector ports 119,219.

When the engine is in operation, fuel exits the fuel metering orifice 223 and flows down (axially) the outside of the pintle surface first along the fuel sleeve 124,224, then along the oxidizer sleeve 126,226. Oxidizer flows down the inside of the oxidizer inlet 114,214 until it meets the pintle tip 128,228, where it is turned radially outward and encounters the axially flowing fuel flow. The two fluid streams then mix, merge and combust. When operating in tripropellant mode, the first feed fuel is turned off and the second feed fuel is turned on, at the valve manifold 172,272,327 allowing a transition from a heavy hydrocarbon based fuel to a hydrogen based fuel or in theory from a cryogenic fuel to a hypergolic fuel. The process can also be accomplished in the inverse. Also, a change of the oxidizer components can be accomplished on-the-fly, but the practical benefits of so doing are may be much lower.

Also, a tripropellant rocket engine 100,300 may comprise an independent, dual sleeve pintle assembly 120,220 that allows the independent control of velocity vector, momentum vector, liquid propellant pressure, propellant volume and vorticity.

Further, a tripropellant rocket engine 100,300 may also comprise an independent single sleeve or fixed sleeve pintle with pressure management to allow conversion between propellant choices within a distribution manifold 171,271,371.

Additionally, adequate sizing of the sleeve 124,224,126,226 area and manifold area of the pintle injector assembly 120,220 allows the injector assembly 120,220 to flexibly operate with any combination of propellants with only minor calibration changes.

Furthermore, changes can be made in flight provided an independent cooling system assembly 160,360 path is maintained to prevent LOX rich shutdown or thermal damage to the engine 300 components. Also, this keeps the engine 300 clean (free of carbon buildup) allowing an easy restart.

In addition, provision of propellant via pressure-feed, electric pump 385,387,389 or turbo pump will allow efficient operation of a space launcher.

Further, these two ideas (that of one or more adjustable sleeves 124,224,126,226 or a fixed sleeve with an adjusted pressure schedule) are the core of a tripropellant rocket engine which would switch between a hydrocarbon fuel, hydrogen or between cryogenic propellant and hypergolic propellants. Hydrocarbon fuel may be defined as any fuel where the molecule is composed of a carbon bonded to hydrogen, oxygen or any organic compound capable of oxidization at a practical rate. Hydrogen fuel may be defined as a liquid cryogenic compound of pure hydrogen or at a supercritical state. Cryogenic propellant may be defined as a liquid that is prevented from existing as a gas due to the reduction of its temperature. Typically any gas liquefied by application of pressure above normal atmospheric and a mild reduction in temperature below ambient. Hypergolic propellant may be defined as any propellant liquid capable of spontaneous exothermic reaction when exposed to another compound. Hypergolic liquids include strong acids such as red-fuming nitric acid, sulfuric acid, nitrogen tetroxide, hydrazine and borane and fluoride compounds. Other oxidizer/reducer liquid agents may also be considered.

The propellant source preferably includes two fuel sources and an oxidizer source. The propellant source may also include any other propellant that is currently known to one of ordinary skill in the art. The fuel source is preferably contained within the fuel tanks 394,396, and, as a non-limiting example, may use propane and then liquid hydrogen-propellant fuel. The fuel source may be a liquid fuel, a gaseous fuel, a fluid fuel, a thixotropic or pseudo-plastic material, and any combination thereof. The fuel source may also be any other type of fuel currently known to one of ordinary skill in the art. Preferably, the fuel source is a liquid fuel, such as, but not limited to, monomethylhydrazine (MMH), kerosene, methane, propane, ammonia, hydrogen and pentaborane. This is because a solid fuel, such as, but not limited to, butadiene mixed with aluminum and perchlorate, is more difficult to throttle or pump without being finely powdered and suspended in a transport fluid. Also, the fuel source may be a liquid mono-propellant fuel, a liquid bi-propellant fuel, or any combination thereof or oxidizable liquid. The oxidizer source is preferably contained within an oxidizer tank 398, and, as a non-limiting example, may be a mono-propellant oxidizer, such as hydrogen peroxide. The oxidizer source may be a liquid oxidizer, a powdered fluid oxidizer, a gaseous oxidizer, and any combination thereof. The oxidizer source may also be any other type of oxidizer currently known to one of ordinary skill in the art. Preferably, the oxidizer source is a liquid oxidizer, such as, but not limited to, nitrogen tetroxide (NTO), hydrogen peroxide, liquid oxygen, nitrous oxide, and nitric acid. Also, the oxidizer source may be a liquid mono-propellant oxidizer, a liquid bi-propellant oxidizer, or any combination thereof or reducible liquid. As a non-limiting example, when a space vehicle relating to this embodiment uses two liquid fuels or a combination, the space vehicle will preferably also use a liquid oxidizer or a combination or hybrid liquid-gas oxidizer, respectively.

The pump power source 382 is considered to be an electric pump 385,387,389, turbo pump, displacement pump, diaphragm pump or any other pump currently known in the art.

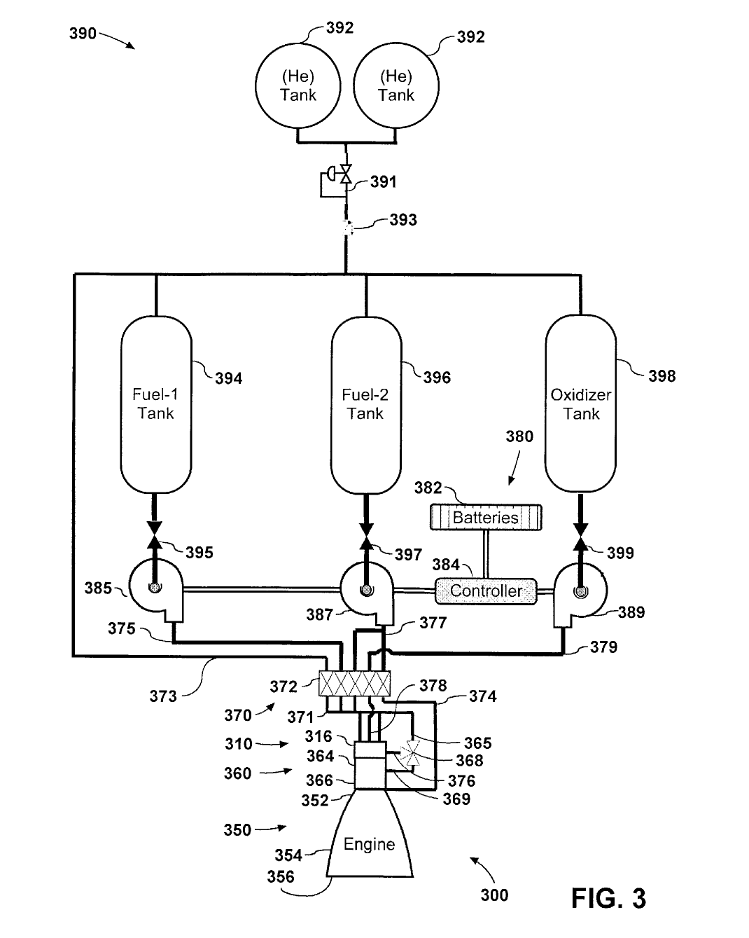

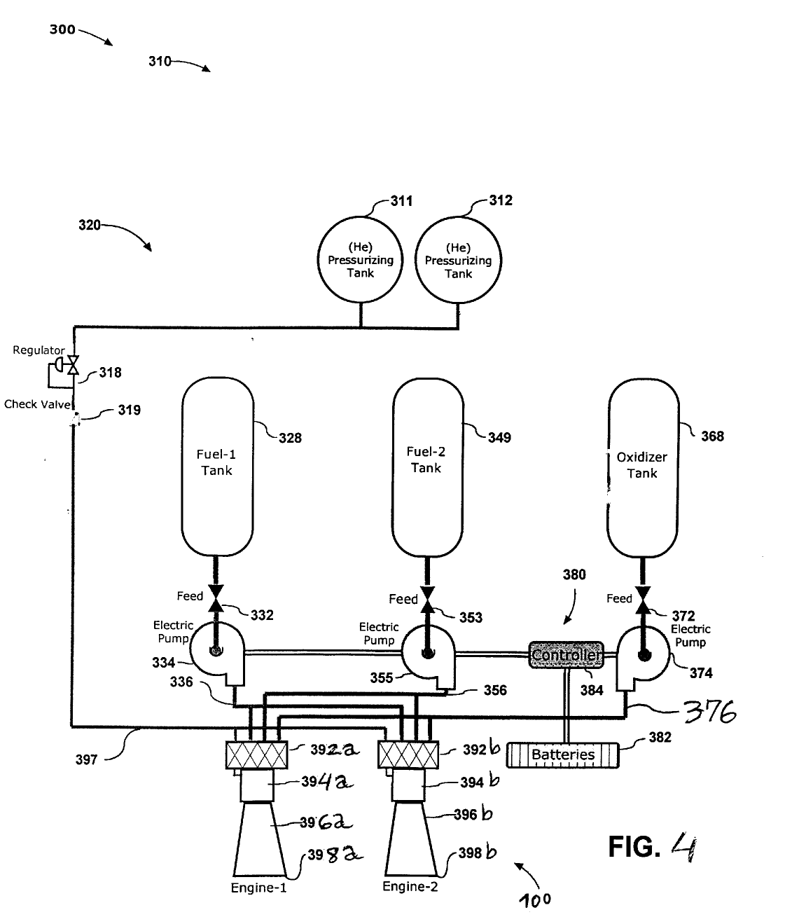

As a non-limiting example, FIG. 3 shows a two fuel/one oxidizer electric pump rocket stage 390 having at least one tripropellant rocket engine 100,300.

The fuel system preferably includes a fuel source, fuel tanks 394,396, feed valves 395,397, electric pumps 385,387, feed lines 175,275,375,177,277,377, and fuel manifold 171,271,371.

The fuel source is preferably contained within the fuel tanks 394,396, and, as a non-limiting example, may be a mono-propellant fuel. The fuel source may be a liquid fuel, a gelled fuel, a solid fuel, a gaseous fuel, a fluid fuel, a thixotropic or pseudo-plastic material, and any combination thereof. The fuel source may also be any other type of fuel currently known to one of ordinary skill in the art. Preferably, the fuel source is a liquid fuel, such as, but not limited to, monomethylhydrazine (MMH), kerosene, methane, propane, ammonia, and pentaborane.

Preferably, the fuel tanks 394,396, feed valves 395,397, electric pumps 385,387, feed lines 175,275,375,177,277,377, and fuel manifold 171,271,371, respectively, are devices that are known to one of ordinary skill in the art.

The oxidizer system preferably includes an oxidizer source, an oxidizer tank 398, a feed valve 399, an electric pump 389, an oxidizer feed line 179,279,379, and an oxidizer line 178,278,378.

The oxidizer source is preferably contained within the oxidizer tank 398, and, as a non-limiting example, may be a mono-propellant oxidizer, such as hydrogen peroxide. The oxidizer source may be a liquid oxidizer, a solid oxidizer, a gaseous oxidizer, and any combination thereof. The oxidizer source may also be any other type of oxidizer currently known to one of ordinary skill in the art. Preferably, the oxidizer source is a liquid oxidizer, such as, but not limited to, nitrogen tetroxide, hydrogen peroxide, liquid oxygen, nitrous oxide, and nitric acid. Also, the oxidizer source may be a liquid mono-propellant oxidizer, a liquid bi-propellant oxidizer, a solid-liquid hybrid propellant oxidizer, or any combination thereof. As a non-limiting example, when a space vehicle relating to this embodiment uses a liquid fuel or a combination or hybrid liquid-solid fuel, the space vehicle will preferably also use a liquid oxidizer or a combination or hybrid liquid-gas oxidizer, respectively. It is also possible to have an additional fuel source of a different character to be mixed in, or switched between during operations.

Preferably, the oxidizer tank 398, a feed valve 399, an electric pump 389, a feed line 179,279,379, and an oxidizer line 178,278,378, respectively, are devices that are known to one of ordinary skill in the art.

The propellant pressurizing system 390 preferably includes a propellant pressurizing source, a pair of propellant pressurizing tanks 392, pressure regulator 391, check valve 393, and gas lines 173,273,373. Preferably, these components are devices currently known to one of ordinary skill in the art.

The propellant pressurizing source is preferably contained within the propellant pressurizing tanks 392. The pressurizing source pressurizes the fuel tank 394,396, and oxidizer tank 398 via gas lines 173,273,373. Preferably, the pressurizing source is a non-reactive gas, such as, but not limited to, helium, argon, neon, and nitrogen.

In operation, the propellant pressurizing system 390 can be used to purge the system 370 during fuel transition and to purge and cool the engine 300 during shutdown, allowing the engine 300 to be restarted without cleaning. These features make the engine 300 suitable for a reusable launch vehicle or rocket stage.

The assembly 380 with a power source and a controller includes a power source 382 and a controller 384.

Preferably, the power source 382 is an electric power source, and at least one electric power source performs at less than 1,000 kw. As non-limiting examples, each electric power source may be or include a battery 382, a fuel cell, a solar cell, a capacitor source, a diode, a transistor, other current control devices, a generator, such as, but not limited to, a mechanical generator and a turbo generator, or any combination thereof or known to the practice. Preferably, each electric power source may be or include multiple batteries 382 that are individually separated, or provided in separate modules, such that each battery can be releasably jettisoned individually from a rocket engine system at different times during a flight when a predetermined altitude is reached. The discarding of the power source, possibly also the controller and electric motor, during a flight helps, or may help, to reduce weight and save fuel and costs, to improve performance of the engine system, and to improve the mass ratio or adjust vehicle center of gravity. The multiple batteries may be connected by battery connectors (or passive conductors or active circuits including diodes, transistors, thyristors, DC-DC convertors, transformers) or any other type of connector that is known to one of ordinary skill in the art. It is obvious to one of ordinary skill in the art that the power source may be a non-electric variety. The above can be improved by adding a blocking diode to each of the modules that are jettisoned and by making the modules of slightly different voltage. They can be either all brought on line simultaneously or jettisoned with reduced current through the ejection fixture. Also, the above can be improved by connecting a spacecraft electrical bus into the motor propulsion bus to provide additional energy. The above batteries can be fed to electromechanical or electro hydraulic actuators, and provide power for the steering actuators.

The controller 384 provides regulated voltage, current, phase, over current protection, and speed control. The controller 384 is preferably connected to or in communication with the multiple batteries 382 and also preferably located between, connected to or in communication with electric pumps 385,387,389.

The tripropellant rocket engines 100,300, or rocket engine assembly 100,300, preferably include throttle valves 172,272,372, a combustion chamber and throat assembly 130, coolant feed lines 174,274,374, nozzle assembly 150,350, and pintle injector assembly 120,220.

Preferably, each nozzle of a nozzle assembly 150,350 is a Lobed nozzle, which preferably means a standard nozzle that can be used on any engine regardless of trajectory. Instead of designing ideal nozzles and needing to manufacture them specifically for the design trajectory starting point, a standard Lobed nozzle can be used on any mission, resulting in lower costs and improving trajectory averaged specific impulse (Isp).

Each pump 385,387,389 is in operative communication with, preferably connected to, a corresponding electric power source motor. Also, each pump 385,387,389 is in operative communication with, preferably connected to, the rocket engine 100,300. Further, each pump 385,387,389 is in operative communication with the propellant source whereby the pump 385,387,389 is able to supply the propellant source to the rocket engine 100,300. Preferably, the pumps 385,387,389 are connected, mechanically or electrically, to one another. As an alternative to a pump and a corresponding electric power source motor, it is obvious to one of ordinary skill in the art that a glandless pump or the like can be used in their place. As non-limiting examples, each pump 385,387,389 may a turbo pump, a mechanical displacement pump, a diaphragm pump, or any combination thereof.

It is possible to use one of the propellants as a coolant for the engine while the other propellant is used as main propellant flow and at a later time use the same propellant as both coolant and propellant main flow.

It is to be understood that the present invention is not limited to the embodiments described above or as shown in the attached figures, but encompasses any and all embodiments within the spirit of the invention.

What is claimed is:

1. A tri-propellant rocket engine for space launch applications comprising:
an injector;
whereis said injector is an independent dual sleeve pintle injector that allows the independent control of velocity vector, momentum vector, liquid propellant pressure, propellant volument and vorticity;
a chamber head, wherein said chamber head serves as a mechanical support for said pintle injector and propellant injection manifolds;
and a chamber.

2. The tri-propellant rocket engine according to claim 1, wherein adequate sizing of a sleeve area and a manifold area of said pintle injector allows said pintle injector to flexibly operate with any combination of propellants with minor calibration changes.

3. The tri-propellant rocket engine according to claim 1, wherein changes can be made in flight provided an independent cooling path is maintained to prevent lox rich shutdown or thermal damage to the engine components.

4. The tri-propellant rocket engine according to claim 1, wherein these two ideas are the core of a tri-propellant rocket engine which would switch between hydrocarbon fuel and hydrogen or between cryo propellant and hypergolic propellants.

5. The tri-propellant rocket engine according to claim 1, wherein propellant source includes two fuel sources and an oxidizer source.

6. The tri-propellant rocket engine according to claim 5, wherein said two fuel sources is selected from the group consisting of a liquid fuel, a gaseous fuel, a fluid fuel, a thixotropic or pseudoplastic material, and any combination thereof, and wherein said oxidizer source is selected from the group consisting of a liquid oxidizer, a powdered fluid oxidizer, a gaseous oxidizer, and any combination thereof.

7. The tri-propellant rocket engine according to claim 6, wherein said liquid fuel is selected from the group consisting of monomethyl hydrazine (MMH), kerosene, methane, propane, ammonia, hydrogen and pentaborane.
